(19) United States
(12) Patent Application Publication
(10) Pub. No.: US 2004/0185568 A1
(43) Pub. Date: Sep. 23, 2004

(54) Sensor storage solution, sensor calibration solution and sensor

(75) Inventor: Toru Matsumoto, Tokyo (JP)

Correspondence Address: YOUNG & THOMPSON, 745 SOUTH 23RD STREET 2ND FLOOR, ARLINGTON, VA, 22202

(73) Assignee: TANITA CORPORATION, TOKYO (JP)

(21) Appl. No.: 10/765,896

(22) Filed: Jan. 29, 2004

(30) Foreign Application Priority Data
Jan. 31, 2003 (JP) 2003-025117

(51) Int. Cl. G01N 31/00

(52) U.S. Cl. 436/8

(57) ABSTRACT

An objective of this invention is to prevent deterioration with time of a storage or calibration solution due to, for example, growth of microorganisms or bacteria. Another objective of this invention is to prevent deterioration of, for example, an enzyme or organic layer in an electrode coating of a sensor caused by a storage or calibration solution. Another objective of this invention is to prevent detachment of an organic layer in an electrode coating from an adjacent layer or electrode, caused by a storage or calibration solution. For achieving these objectives, a storage solution 23 and a calibration solution in a sensor comprising an enzyme electrode 18 comprise an electrolyte, a pH buffering agent and a compound containing a heterocycle having nitrogen and sulfur heteroatoms.

This application is based on Japanese patent application NO.2003-25117, the content of which is incorporated hereinto by reference.

### BACKGROUND OF THE INVENTION

1. Field of the Invention

This invention relates to a sensor for detecting a particular component in a liquid, a storage solution therefor and a calibration solution therefor.

2. Description of the Prior Art

For measuring a variety of components contained in a sample such as a biological sample, a combination of an enzyme reaction and an electrochemical reaction is commonly used. A biosensor is one of sensors utilizing such a system, in which a particular component in a sample is converted by an enzyme action into another substance, which is then measured by an oxidation-reduction reaction.

Such a sensor has been described in Japanese Laid-open Patent Publication No.2000-81409. FIG. 1 shows an example of a sensor described in the reference. The shown sensor has a configuration where on an insulating substrate 6 is formed an electrode 10, on which are sequentially deposited a binding layer 7, an immobilized enzyme layer 8 and a permeation limiting layer 9. The permeation limiting layer 9 is formed on the immobilized enzyme layer 8 where an enzyme reaction occurs, so that a wider measurement range can be achieved while excluding influence of interfering materials on desired measurement. The binding layer 7 between the electrode 10 made of a metal and the immobilized enzyme layer 8 made of an organic material can improve adhesion between them, resulting in improved durability of the sensor. In other words, the sensor comprises, in addition to the enzyme-containing layer, organic material layers responsible for various functions, which improve performance and reliability of the sensor.

When conducting repeated measurement using such a biosensor, it is important to store the sensor in a favorable state after measurement. Generally, except when being in use, a sensor is immersed in a storage solution for maintaining its current or voltage stable, and immediately before use, it is calibrated using a calibration solution before measurement. Such a storage or calibration solution is generally a pH buffer.

However, when a conventional storage or calibration solution is used for storing or calibrating a sensor, detachment of a film constituting the sensor, inactivation of an enzyme in the sensor and/or growth of a mold in the storage solution sometimes occur. Main reasons for detachment may include thermal expansion stress, stress on voltage application and influence of an excess current. A main reason for inactivation of an enzyme and growth of a mold in the storage solution may be exogenous microorganisms or bacteria brought during measurement, which are grown in the storage solution and attach to the films constituting the sensor, leading to deterioration of sensor function and pH reduction of the storage solution. Such a phenomenon becomes prominent at an elevated temperature of 40° C. or higher. When continuing the use of the sensor in spite of the phenomenon, measurement accuracy may be sometimes lowered.

There have been many investigations for endowing a sensor storage solution with antibacterial and antiseptic properties. For example, Japanese Laid-open Patent Publication No.2000-74870 has disclosed that an azide such as sodium azide can be added a sensor storage solution to improve antibacterial property of the storage solution.

However, an azide is extremely oxidative so that it tends to oxidatively decompose and damage organic films or an enzyme used in the sensor. Depending on the conditions of voltage application, an azide may be irreversibly adsorbed by the sensor, leading to significant deterioration of sensor properties.

An objective of this invention, which solves the above problems in the prior art is to prevent deterioration with time of a storage or calibration solution due to, for example, growth of microorganisms or bacteria. Another objective of this invention is to prevent deterioration of, for example, an enzyme or organic layer in an electrode coating of a sensor caused by a storage or calibration solution. Another objective of this invention is to prevent detachment of an organic layer in an electrode coating from an adjacent layer or electrode, caused by a storage or calibration solution.

### SUMMARY OF THE INVENTION

This invention provides a sensor storage solution comprising a compound containing a heterocycle having nitrogen and sulfur heteroatoms.

This invention also provides a sensor calibration solution comprising a compound containing a heterocycle having nitrogen and sulfur heteroatoms.

This invention also provides a process for storing a sensor, comprising immersing the sensor in the storage solution as described above for storage. This invention also provides a process for calibrating a sensor, comprising contacting the sensor with the calibration solution as described above for calibration.

According to this invention, a compound having the particular structure can effectively prevent deterioration with time of a storage or calibration solution due to, for example, growth of microorganisms or bacteria. It can also prevent deterioration of an enzyme or organic layer in an electrode coating in a sensor caused by a storage or calibration solution, and detachment of an organic layer in an electrode coating in a sensor from an adjacent layer or electrode. Although the reason why the compound having the particular structure can be used to achieve such effects is not clearly understood, the effects might be achieved presumably because S (sulfur) contained in the heterocycle inhibits growth of microorganisms or bacteria, and N (nitrogen) contained in the heterocycle is adsorbed in a sensor surface to form a protective film in the sensor surface.

This invention also provides a sensor comprising a substrate, an electrode formed on the substrate and a coating covering the electrode wherein the coating comprises a compound containing a heterocycle having nitrogen and sulfur heteroatoms.

In this sensor, the coating may have a multilayer structure comprising one or more organic layers. The coating may comprise an enzyme.

The sensor of this invention comprises the electrode coating comprising a compound having the particular structure, so that during storage of the sensor, deterioration of performance of the coating and interlayer detachment can be prevented and deterioration in adhesiveness between the coating and the electrode can be prevented. Although the reason is not clearly understood, the effects can be achieved presumably because N (nitrogen) contained in the heterocycle is adsorbed in a sensor surface to form a protective film in the sensor surface. In the sensor of this invention, a compound having the particular structure may be attached to the coating surface or contained in the coating. The term, an “organic layer” as used herein refers to a layer mainly made of an organic compound which is formed over an electrode, including a binding layer, an ion-exchange resin layer, an immobilized enzyme layer and a permeation limiting layer which will be described below.

This invention can be suitably applied to a sensor for measuring an urine glucose level or a storage or calibration solution for the sensor. A working environment during urinary glucose measurement (urine glucose determination) is more severe than that in blood glucose determination because urine glucose determination is generally conducted in a rest room and it is, of course, extremely probable that a storage solution is contaminated with various germs. According this invention, sensor performance can be satisfactorily maintained even such a severe working environment.

### BRIEF DESCRIPTION OF THE DRAWINGS

FIG. 1 shows a cross section of a sensor according to the prior art.

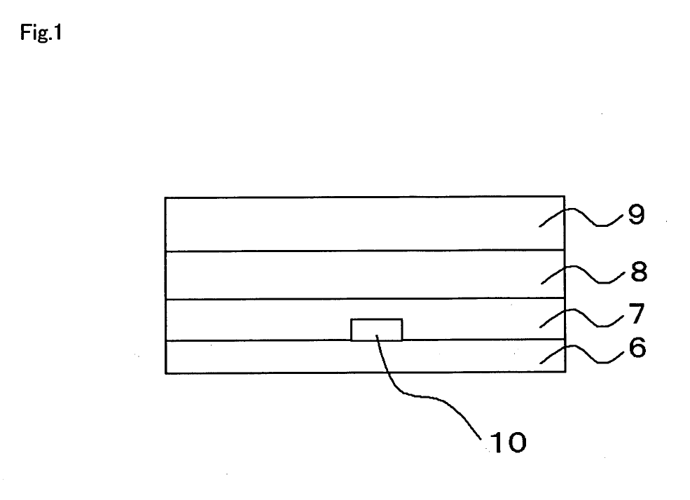

FIG. 2 shows a cross section of a sensor according to an embodiment of the present invention.

FIG. 3 shows stability of a sensor according to an example.

FIG. 4 shows stability of a sensor according to an example.

FIG. 5 shows stability of a sensor according to an example.

FIG. 6 shows stability of a sensor according to an example.

FIG. 7 shows stability of a sensor according to an example.

FIG. 8 shows a configuration of a measuring apparatus according to an embodiment of this invention.

FIG. 9 shows a stand-by state of the measuring apparatus in FIG. 8.

FIG. 10 illustrates a process for measuring an urine glucose level using the measuring apparatus in FIG. 8.

FIG. 11 shows a configuration of a sensor which can be used in an embodiment of this invention.

In these drawings, the symbols carry the following meanings; 3: counter electrode, 4: reference electrode, 5: working electrode, 6: insulating substrate, 7: binding layer, 8: immobilized enzyme. layer, 9: permeation limiting layer, 10: electrode, 11: organic layer, 12: adhesive material, 17: operation button, 18: enzyme electrode, 19: measurement display, 20: stand, 21: calibration solution container, 22: body, 23: storage solution, 24: storage solution container, 25: calibration solution, 26: urine sample, 27: tap water, 28: waste water, 39: sensor holder, 40: base electrode, 41: metal electrode, 42: insulating film, 43: immobilized enzyme film, 44: lower protective film, 45: immobilized enzyme layer, 46: upper protective film, 47: surface protective film, and 48: planer type enzyme sensor.

### DETAILED DESCRIPTION OF PREFERRED EMBODIMENTS

Embodiment 1

In this embodiment, there will be described an example of a process for storing a sensor in a storage solution for a measuring apparatus comprising an enzyme electrode as the sensor. A case where an urine glucose level is determined will be herein described.

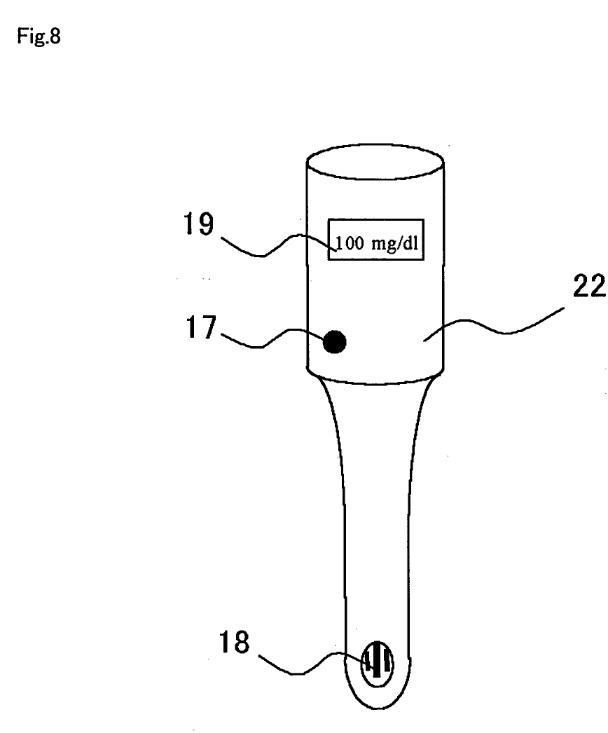

FIG. 8 shows a configuration of a measuring apparatus according to this embodiment. In the figure, a body 22 comprises an operation button 17, an enzyme electrode 18 and a measurement display 19. The body 22 houses a driving circuit, a power circuit and a clock for the enzyme electrode 18 (None of all are shown). The operation button 17 is a button for an operation such as measurement, calibration of the enzyme electrode and reading data. The enzyme electrode 18 corresponds to a sensor, with which a sample is contacted for measurement. The measurement display 19 indicates measurement data for an urine glucose level, operation procedures, timing of replacing a battery and the enzyme electrode and a time.

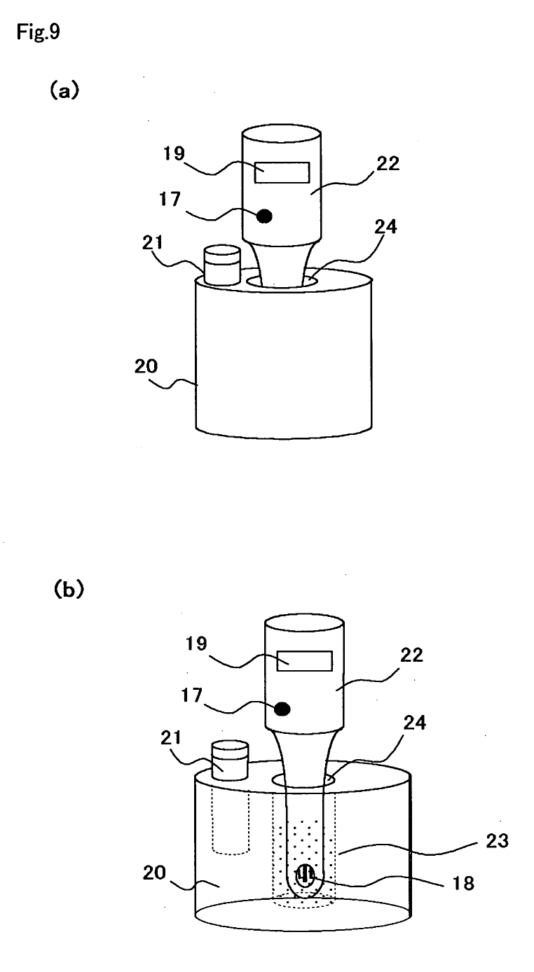

FIG. 9(a) and FIG. 9(b) illustrate the body 22 of the measuring apparatus which is mounted in a stand 20.

FIG. 9(a) shows an external appearance when the sensor is mounted, and FIG. 9(b) shows an internal structure of the stand 20. The stand 20 comprises a calibration solution container 21 filled with a calibration solution used for calibrating the measuring apparatus. The stand 20 also comprises a storage solution container 24 filled with a storage solution 23 in which the measuring apparatus is immersed for storage. When not being used, the sensor of the measuring apparatus is immersed in the storage solution 23 as shown in the figure. In a stand-by state before use of the measuring apparatus, a constant voltage may be kept being applied to an electrode system such as a working electrode. An applied voltage is, for example, 0.1 to 0.8 V to a reference electrode when using a silver/silver chloride electrode as the reference electrode.

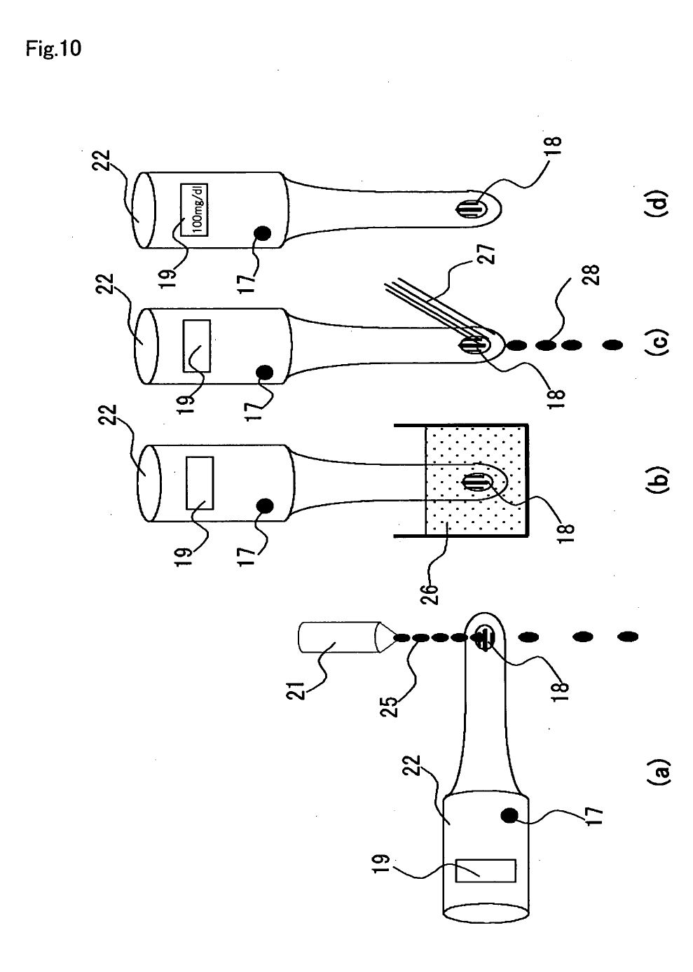

FIG. 10(a) to FIG. 10(d) show a process for determining an urine glucose level using the measuring apparatus in FIG. 8. First, as shown in FIG. 10(a), a calibration solution 25 is dropped to the enzyme electrode 18 in the body 22 removed from the stand 20 to calibrate the enzyme electrode 18. Then, as shown in FIG. 10(b), the enzyme electrode 18 is immersed in an urine sample 26 to determine an urine glucose level. After measurement, the urine sample 26 remaining on the surface of the enzyme electrode 18 is washed out with tap water 27 and discharged as a waste water 28, as shown in FIG. 10(c). Then, as shown in FIG. 10(d), the measurement display 19 in the body 22 indicates measured values. The above operation shown in FIGS. 10(a) to (d) is repeated for further measurement. After measurement, the enzyme electrode 18 is immersed in the storage solution 23 for storage, as shown in FIG. 9(a) and FIG. 9(b). A measuring apparatus in which measured values are indicated from the step in FIG. 10(b) may be used.

In this embodiment, both of the storage solution 23 and the calibration solution 25 contain (a) electrolyte, (b) a pH buffering substance (hereinafter, referred to as a “pH buffering agent”) and (c) a compound containing a heterocycle having nitrogen and sulfur heteroatoms. The calibration solution 25 also contains a calibration substance at a known concentration.

Component (a), an electrolyte, may be a substance used as a supporting electrolyte for the pH buffering agent, such as a chloride and a nitrate. A chloride which is suitably used may be inexpensive, low-toxic and easily hydrated, including preferably sodium chloride, potassium chloride, calcium chloride and magnesium chloride, particularly magnesium chloride which is less reactive to the above component (c). A nitrate which is suitably used is magnesium nitrate for a similar reason. A chloride concentration in the storage solution 23 or the calibration solution 25 is preferably 0.005 ppm to 100 ppm both inclusive, more preferably 0.05 ppm to 50 ppm both inclusive. A nitrate concentration in the storage solution 23 or the calibration solution 25 is preferably 0.01 ppm to 100 ppm both inclusive, more preferably 0.1 ppm to 100 ppm both inclusive. By selecting such concentrations, component (c) can stably exist in the solutions and the sensor comprising the enzyme electrode can be reliably-stored and calibrated.

Component (b), a pH buffering agent, is used for preventing pH fluctuation and deterioration of the storage solution 23 or the calibration solution 25. Examples of the pH buffering agent include N-tris(hydroxymethyl)methyl-2-aminoethanesulfonic acid (TES), 2-[4-(2-hydroxyethyl)-1-piperazinyl]ethanesulfonic acid (HEPES), 2-morpholinoethanesulfonic acid monohydrate (MES) and piperazine-1,4-bis(2-ethanesulfonic acid) (PIPES). Its concentration may be, for example, 1 to 200 mM.

The compound as component (c) is used for inhibiting growth of bacteria or microorganisms in the storage solution 23 and for preventing detachment of various organic films constituting a sensor. Using the storage solution 23 and the calibration solution 25 containing the compound, the compound adheres to the surface of the electrode section in the sensor to prevent an excess current from flowing in the electrode. As a result, even after long-term use of the enzyme electrode 18, damage to an organic layer such as an immobilized enzyme layer over the electrode or detachment of the organic layer from the electrode can be prevented. Such a compound has an antifouling effect, so that the electrode surface can be protected and thus sensor properties can be reliably maintained for a long time.

The compound of component (c) is a monocyclic or polycyclic compound containing S (sulfur) and N (nitrogen). Although this compound may be either monocyclic or polycyclic, it is preferably a 4 to 6-membered monocyclic compound, more preferably a five to six-membered monocyclic compound for more reliably achieving the effects of this invention. Thus, the compound of component (c) can has a more stable structure in a liquid. An example of a polycyclic compound may be 1,2-benzoisothiazolin-3-one.

Specific examples of the above compound include:

thiazoles such as 1,3-thiazole (thiazole), 2-thiazoline, 3-thiazoline, 4-thiazoline and their derivatives;

isothiazoles such as 1,2-thiazole (isothiazole), 2-isothiazoline, 3-isothiazoline, 4-isothiazoline and their derivatives;

thiazines such as 1,2-thiazine, 1,3-thiazine, 1,4-thiazine and their derivatives;

compounds containing two or more nitrogen atoms and one or more double bond in a heterocycle such as thiadiazole, thiatriazole, thiadiazine and their derivatives;

compounds in which a heterocycle structure is constituted with single bonds, such as thiazolidine, thiadiazolidine and their derivatives.

The derivatives described above may include oxides containing an oxo group (═O), halides and alkylated derivatives. Specific examples may include those containing oxo, halogen and/or alkyl directly bound to a heterocycle. The compound may contain one or more of these different substituents.

Among these derivatives, a thiazolinone, isothiazolinone, thiazinone or its derivative can be used to effectively prevent deterioration with time of the storage solution 23 or the calibration solution 25 as well as to considerably prevent deterioration of an enzyme or organic layer in the sensor and detachment of an organic layer, which are caused by the storage solution 23 or the calibration solution 25.

An isothiazolin-3-one represented by general formula (1) can be suitably used because it exhibits particularly excellent storage properties for a sensor.

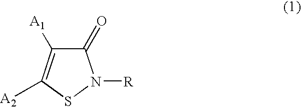

wherein R represents hydrogen or substituted or unsubstituted alkyl having 1 to 10 carbon atoms; A₁ and A₂ independently represent a monovalent radical such as halogen, hydrogen, alkyl and alkenyl; and A₁ and A₂ may be combined together to form a ring.

Examples of the compound represented by general formula (1) include compounds represented by general formulas (2) and (3). In these formulas, X represents halogen such as Cl and Br; and R represents hydrogen or substituted or unsubstituted alkyl having 1 to 10 carbon atoms. An example of the compound represented by general formula (2) may be 2-methyl-4-isothiazolin-3-one.

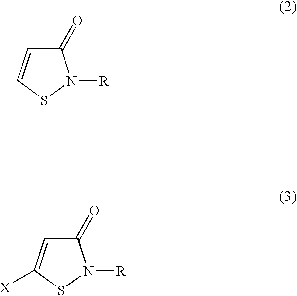

In addition to the above compounds, one or more substances selected from the group consisting of thiazoline, thiazole, isothiazole, thiadiazole, thiatriazole, thiazolidine, thiadiazolidine and their oxides, halides and alkylated derivatives may be used. A four- or six-membered cyclic compound may be used. These substances may be used to effectively prevent detachment of an organic layer from an electrode. The structures of these compounds are shown below. In these formulas, R represents hydrogen or substituted or unsubstituted alkyl having 1 to 10 carbon atoms, preferably methyl, ethyl or propyl, particularly methyl in the light of solubility and stability in the storage solution 23 or the calibration solution 25. X represents halogen such as Cl.

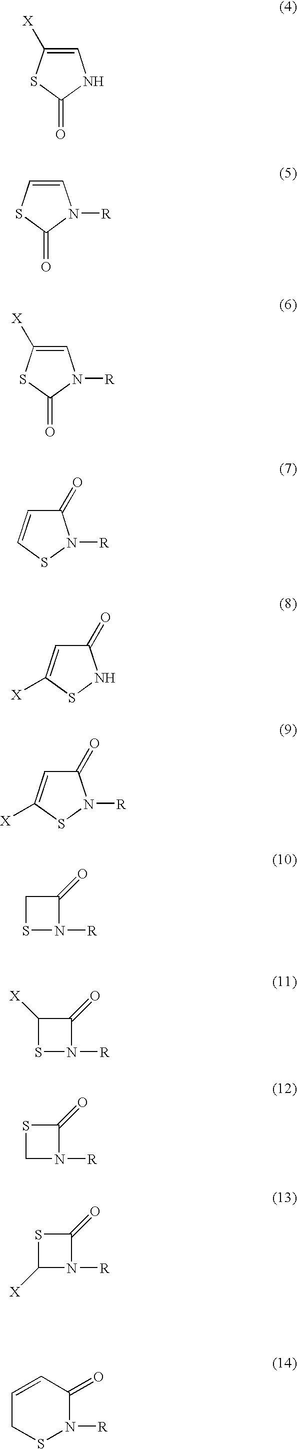

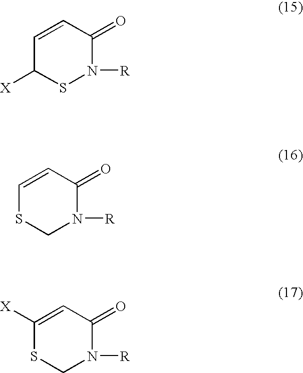

It is known that among those illustrated, a compound having an amide moiety in a ring may exist as tautomers in which the amide moiety is reversibly converted into an iminohydrin moiety, where oxo (═O) attached to the ring is converted to hydroxy (—OH).

In this embodiment, the above compounds may be used alone or in combination of two or more, as component (c).

An example of the compound represented by formula (6) may be 5-chloro-3-methyl-4-thiazolin-2-one represented by formula (18). An example of the compound represented by formula (9) may be 5-chloro-2-methyl-4-isothiazolin-3-one represented by formula (19).

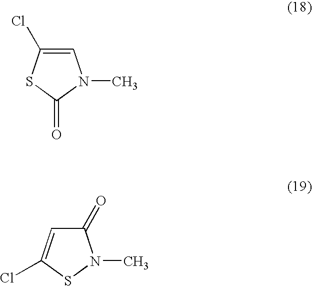

Alternatively, 4,5-dichloro-2-octyl-4-isothiazolin-3-one or 4,5-dichloro-2-octyl-4-isothiazoline represented by formula (20) may be used.

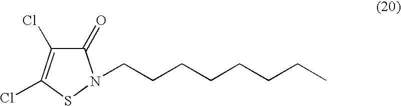

These compounds particularly exhibit excellent storage properties for a sensor. For example, Caisson WT or KLARIX4000® Microbicide from Rohm and Haas may be used. Such a compound may be combined with the compound represented by general formula (2) such as 2-methyl-4-isothiazolin-3-one.

When using an oxide of isothiazole such as isothiazolinone as component (c), a concentration of the oxide of isothiazole in the storage solution 23 or the calibration solution 25 is 0.001 ppm to 100 ppm both inclusive, more preferably 0.05 ppm to 50 ppm both inclusive. Such a concentration is sufficient to prevent film detachment.

In the above embodiment, the compound of component (c) such as isothiazolinone adheres to the sensor surface to prevent an excess current from flowing when applying a given voltage to a working electrode in the sensor. Thus, damage to the immobilized enzyme layer formed on the electrode or detachment thereof can be prevented, which will be described later in Examples.

The compound of component (c) has an effect of inhibiting growth of bacteria or microorganisms. Although the reason has not been clearly elucidated, Journal of Industrial Microbiology, Vol. 1, p.49 (1986) has described that isothiazolinone causes damage to a cytoplasmic membrane of a microorganism, resulting in impairment in permeability of the membrane and depending on the type of the microorganism, inhibits protein synthesis, leading to inhibition of biosynthesis of the cytoplasmic membrane.

Thus, the storage solution 23 and the calibration solution 25 according to this embodiment which comprise the above component (c) have the following effects:

(i) detachment of various organic films constituting a sensor can be prevented probably because the compound of component (c) is specifically adsorbed in an electrode surface so that it can prevent an excess current from flowing in the sensor; and

(ii) growth of bacteria or microorganisms in the solutions is inhibited, so that their quality can be kept for a long time because the compound of component (c) has a particular molecular structure contributing to antibacterial and antifouling effects.

The storage solution 23 and the calibration solution 25 in this embodiment are more effective when being used as a storage solution 23 and a calibration solution 25 in an urine glucose sensor for determining a glucose level in urine (urine glucose). It is because quality deterioration of the storage solution 23 can be prevented under the conditions in which the system may be easily contaminated with various germs, and thus the urine glucose sensor can be reliably applied to urine glucose determination without deterioration in performance of the sensor. The storage solution 23 and the calibration solution 25 in this embodiment can be used as a storage solution 23 in a sensor without an immobilized enzyme layer, i. e., a hydrogen peroxide sensor.

Embodiment 2

In this embodiment, there will be described an example of a biosensor comprising an organic layer containing an enzyme. The biosensor comprises a body as shown in FIG. 8, in which an enzyme electrode 18 is a detector for a measuring target, i. e., a sensor.

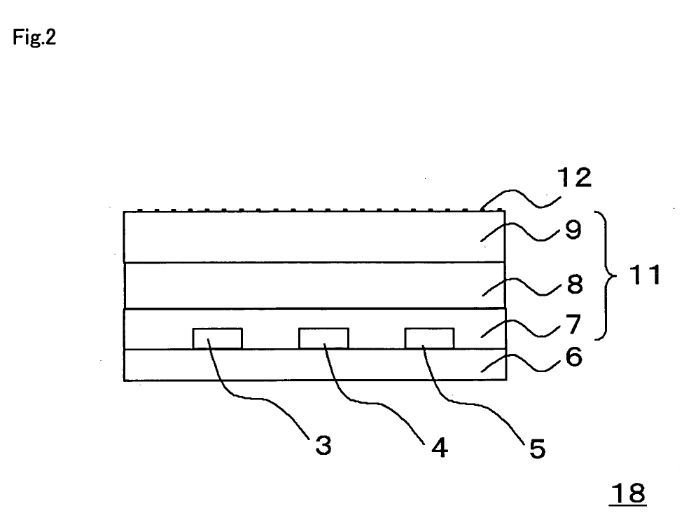

FIG. 2 is a cross section illustrating a configuration of a sensor, i. e., an enzyme electrode 18, in the biosensor according to this embodiment. On an insulating substrate 6 are formed a counter electrode 3, a reference electrode 4 and a working electrode 5. On these electrodes are sequentially deposited a binding layer 7, an immobilized enzyme layer 8 and a permeation limiting layer 9. Hereinafter, the counter electrode 3, the reference electrode 4 and the working electrode 5 are collectively called an “electrode” as appropriate. Hereinafter, the binding layer 7, the immobilized enzyme layer 8 and the permeation limiting layer 9 are collectively called an “organic layers” 11.

As described in embodiment 1, the enzyme electrode 18 is stored while being immersed in a storage solution 23 comprising a compound containing a heterocycle having nitrogen and sulfur heteroatoms, and is calibrated using a calibration solution 25 comprising the compound before the use of the sensor. The enzyme electrode 18 shown in FIG. 2 is in a state after such an operation, in which an adhesive material 12 consisting of the above compound adheres to the surface of the permeation limiting layer 9. Thus, deterioration with time of film properties can be significantly prevented when the sensor is immersed in the storage solution 23 for storage while being not in use.

The components constituting a sensor will be described with reference to FIG. 2.

The insulating substrate 6 may be preferably made of, but not limited to, glass, quartz or a plastic, particularly glass in the light of durability.

An electrode may be made of a material such as gold, platinum, silver, carbon and their compounds. For example, the counter electrode 3 and the working electrode 5 are preferably made of platinum because of its durability and chemical resistance. The reference electrode 4 may be preferably made of silver and silver chloride. An electrode may be formed by a common process such as, but not limited to, sputtering, vacuum deposition and chemical vapor deposition. Sputtering is preferable because a homogeneous electrode can be prepared.

The binding layer 7 improves adhesiveness (binding strength) of the immobilized enzyme layer 8 thereon to the electrode. It is also effective in improving wettability of the surface of the insulating substrate 6 and thickness uniformity during forming the immobilized enzyme layer 8 in which an enzyme is immobilized. The binding layer 7 is mainly made of a silane coupling agent. Examples of a silane coupling agents which may be used include aminosilanes, vinylsilanes and epoxysilanes. Among these, y-aminopropyltriethoxysilane, an aminosilane, is particularly preferable in the light of adhesiveness and selective permeation.

The binding layer 7 may be formed by, for example, spin coating of a silane coupling agent solution, where a concentration of the silane coupling agent is preferably about 1 v/v % for significantly improving selective permeability. The binding layer 7 may be formed by any process providing a layer with an even thickness without limitations, including screen printing, spray coating and dip coating in addition to spin coating.

The immobilized enzyme layer 8 comprises an organic polymer base material in which a catalytic enzyme is immobilized. The immobilized enzyme layer 8 may be formed by, for example, adding dropwise a solution containing some kind of enzyme, a protein cross-linking agent such as glutaraldehyde and albumin on the binding layer 7, and then extending the solution by spin coating. Albumin may protect the enzyme from a reaction with the cross-linking agent and may be a protein base material. Examples of an enzyme to be immobilized include lactate oxidase, glucose oxidase, urico-oxidase, galactose oxidase, lactose oxidase, sucrose oxidase, ethanol oxidase, methanol oxidase, starch oxidase, amino acid oxidase, monoamine oxidase, cholesterol oxidase, choline oxidase and pyruvate oxidase, which generate hydrogen peroxide as a product of their catalytic reaction or consume oxygen.

Two or more enzymes may be used in combination for generating hydrogen peroxide; for example any combination of creatininase, creatinase and sarcosine oxidase. Such a combination can be used to detect creatinine. An enzyme may be combined with a coenzyme; for example, a combination of 3-hydroxylactate dehydrogenase and nicotinamide adenine dinucleotide (NAD) oxidase. Such a combination can be used to detect 3-hydroxylactic acid. Furthermore, an enzyme may be combined with an electron mediator, where an electron mediator which has been reduced by the enzyme is oxidized on the electrode surface to generate a current which is then measured. Using such a combination, for example, combination of potassium ferricyanide and glucose oxidase, glucose can be detected.

As described above, there are no limitations to the structure of the immobilized enzyme layer 8 as long as it contains at least an enzyme and can convert a measurement target into an electrode sensitive substance such as hydrogen peroxide. The immobilized enzyme layer 8 can be formed by any process without limitations as long as a uniform layer can be formed, including screen printing, spray coating and dip coating, in addition to spin coating.

The permeation limiting layer 9 limits a diffusion rate of a component to be measured and reduces influence of interfering substances, contributing to improvement of measurement accuracy and expansion of a measurable range. The permeation limiting layer 9 may be preferably made of, for example, polydimethylsiloxane or a fluoroalcohol ester of a polycarboxylic acid. A fluoroalcohol ester of a polycarboxylic acid as used herein means a polycarboxylic acid derivative in which some or all of carboxyl groups in the polycarboxylic acid are esterified with a fluoroalcohol. A fluoroalcohol as used herein means an alcohol, all or at least one of whose hydrogens are replaced with fluorines. Thus, there can be provided a measuring apparatus in which adhesion of contaminants such as proteins and urea derivatives is effectively prevented and which can exhibit stable output properties even after a long-term use. A fluoroalcohol ester group is insoluble in most non-fluorinated solvents or detergents such as surfactants so that an enzyme electrode 18 with good chemical resistance can be provided.

The permeation limiting layer 9 may be formed by adding dropwise a solution of a fluoroalcohol ester of methacrylate resin in a perfluorocarbon solvent such as perfluorohexane on the immobilized enzyme layer 8 in which acatalytic enzyme is immobilized and extending the solution by spin coating. The concentration of the methacrylate resin in fluoroalcohol ester solution may be 0.1 to 5 wt %, preferably about 0.3 wt %, depending on a measurement target because a concentration within the range may, as described later, provide good permeation-limiting property. The permeation limiting layer 9 may be formed by any process without limitations as long as a layer with a uniform thickness may be formed, including spray coating and dip coating, in addition to spin coating.

Thus, the binding layer 7, the immobilized enzyme layer 8 and the permeation limiting layer 9 can be formed as uniform films by a convenient process and can be satisfactorily mass-produced.

As described above, the enzyme electrode 18 according to this embodiment has a multilayer structure consisting of organic layers, each of which plays a unique role. Thus, combination of the functions of these layers results in a high-performance and highly reliable sensor, although it may lead to insufficient adhesion between organic layers and/or interlayer detachment during long-term use of the sensor.

For solving the problems, the enzyme electrode 18 according to this embodiment has a structure in which an adhesive material 12 made of a compound containing a heterocycle having nitrogen and sulfur heteroatoms adheres to the electrode surface. Specifically, the compounds as described in Embodiment 1 can be used. The adhesive material 12 made of the compound can be disposed to effectively prevent detachment of a film constituting a sensor or inactivation of an enzyme contained in the immobilized enzyme layer 8. In addition, when the enzyme electrode 18 is immersed in the storage solution 23, a given voltage is sometimes applied. Even in such a case, flowing of an excess current in the electrode is prevented, so that the properties of the enzyme electrode 18 can be favorably maintained.

The adhesive material 12 can be attached to the surface of the organic layer 11 by immersing the enzyme electrode 18 in the storage solution 23 described in Embodiment 1. In this process, when using, for example, an oxide of isothiazole such as isothiazolinone as the adhesive material 12, a concentration of the oxide of isothiazole in the storage solution 23 is preferably 0.001 ppm to 100 ppm both inclusive, more preferably 0.05 ppm to 50 ppm both inclusive. In addition, while immersing the enzyme electrode 18 in the storage solution 23, a given voltage can be applied to the electrode.

This invention has been described with reference to the above embodiments. However, as apparent to the skilled in the art, these embodiments are only illustrative, many variations are possible and these variations fall within the scope of this invention.

For example, in Embodiment 2, an ion-exchange resin having a perfluorocarbon backbone may intervene between the binding layer 7 and the immobilized enzyme layer 8, to prevent interfering substances for measurement from reaching the electrode. For example, it can prevent ascorbic acid from reaching the electrode in a glucose sensor comprising glucose oxidase.

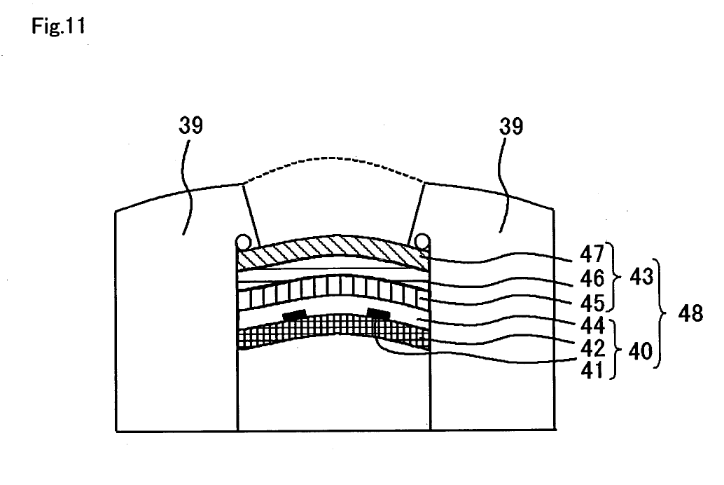

These embodiments have been described mainly in terms of a triode type enzyme electrode, but a diode type enzyme electrode without a reference electrode may be employed. FIG. 11 shows an example of such a sensor. The illustrated sensor comprises an amperometric type enzyme electrode which detects urine glucose. With reference to FIG. 11, on an insulating film 42 consisting of a ceramic or resin film is formed a metal electrode 41 consisting of a platinum, a gold and a silver films. Over the surface are formed a lower protective film 44 consisting of an acetylcellulose film such that the film covers the metal electrode 41, and then an immobilized enzyme layer 45 in which an enzyme is immobilized. On the surface are formed an upper protective film 46 consisting of an acetylcellulose film and then a surface protective film 47 made of latticed Nylon or polycarbonate for further enhancing the function of the upper protective film 46.

In this sensor, the part consisting of the insulating film 42 and the metal electrode 41 is defined as a base electrode 40 acting as a planer type hydrogen peroxide electrode, while the part consisting of the lower protective film 44, the immobilized enzyme layer 45, the upper protective film 46 and the surface protective film 47 is defined as an immobilized enzyme film 43. The combination of the base electrode 40 and the immobilized enzyme film 43 is defined as a planer type enzyme sensor 48. A sensor holder 39 acts as a case holding the planer type enzyme sensor 48. The storage solution and the calibration solution according to this embodiment are also effective for such a sensor. Furthermore, it may be effective that a compound having the above particular structure is attached to the surface of the surface protective film 47 in this sensor. This compound may be as listed in Embodiment 1.

Although the above embodiments have been described in terms of an amperometric sensor, a sensor in a measuring apparatus according to this embodiment may be used as a potentiometric sensor, or, this invention may be applied to a sensor using an FET such as ISFET (Ion Sensitive Field Effect Transistor).

For various sensors, any measurement target may be used without limitations. For example, a sensor may be used for determining a particular component in a sample or a reaction product obtained from an enzyme reaction as well as measuring a pH or temperature.

### EXAMPLES

### Example 1

On a 10 mm×6 mm quartz substrate were formed a working electrode of platinum (area: 7 mm²), a counter electrode (area: 4 mm²) and a reference electrode of silver/silver chloride (area: 1 mm²).

Then, on the overall surface was spin-coated a 1 v/v % solution of γ-aminopropyltriethoxysilane to form a binding layer, on which was spin-coated a 22.5 w/v % solution of albumin containing glutaraldehyde at 1 v/v %, to form an immobilized enzyme layer.

Then, over the whole surface of the immobilized enzyme layer was spin-coated a fluoroalcohol ester of a methacrylate resin prepared as a 0.3 wt % solution in perfluorohexane, and the product was dried to form a permeation limiting layer. Spin coating was conducted under the conditions of 3000 rpm and 30 sec. The fluoroalcohol ester of a methacrylate resin was Florard 722 (Sumitomo 3M), 1H,1H-perfluorooctyl polymethacrylate with a number average molecular weight (Mn) of about 7000 as measured by GPC. Perfluorohexane as a diluent was Florard 726 (Sumitomo 3M).

The sensor thus prepared was immersed in the storage solutions having the compositions shown in Table 1 at 40° C., and observed for the state of the sensor surface by optical microscopy. Observation was conducted after immersion for seven days. In Table 1, “*” and “**” denote 5-chloro-2-methyl-4-isothiazolin-3-one and 2-methyl-4-isothiazolin-3-one, respectively, and MgCl₂, Mg(NO₃)₂, TES, NaN₃ and NaCl denote magnesium chloride, magnesium nitrate, N-tris(hydroxymethyl)methyl-2-aminoethanesulfonic acid, sodium azide and sodium chloride, respectively.

TABLE 1

| | | | Referential |
|---|---|---|---|
| | Storage | Storage | storage |
| | solution 1 | solution 2 | solution |
| 5-c-2-m-4-I-3-o* | 0.209 ppm | 2.089 ppm | 0 ppm |
| 2-m-4-I-3-o** | 0.072 ppm | 0.716 ppm | 0 ppm |
| MgCl₂ | 0.128 ppm | 1.28 ppm | 0 ppm |
| Mg(NO₃)₂ | 0.398 ppm | 3.98 ppm | 0 ppm |
| TES | 100 mM | 100 mM | 100 mM |
| NaCl | 150 mM | 150 mM | 150 mM |
| NaN₃ | 0 ppm | 0 ppm | 0.1 ppm |
| pH | 7 | 7 | 7 |

*5-Chloro-2-methyl-4-isothiazolin-3-one
**2-Methyl-4-isothiazolin-3-one

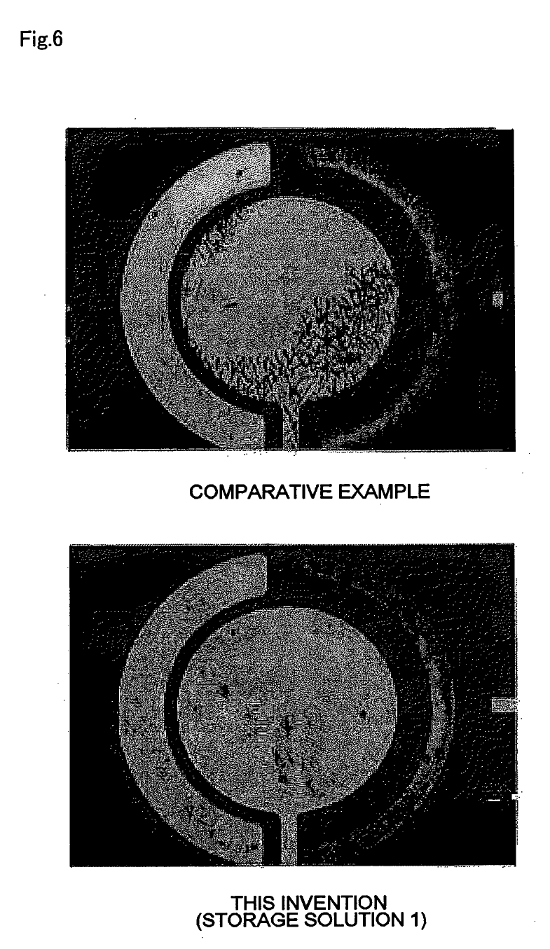

As a result, it was observed that there were no film detachments in storage solutions 1 or 2, while in the referential storage solution, there were innumerable cracks in the film surface and grown cracks led to detachment. FIG. 6 shows the results for the referential storage solution with cracks and the storage solutions without a crack.

Analysis of the surfaces of the sensors indicated that 5-chloro-2-methyl-4-isothiazolin-3-one and 2-methyl-4-isothiazolin-3-one were attached to the sensors immersed in storage solutions 1 and 2, respectively.

### Example 2

On a 10 mm×6 mm quartz substrate were formed a working electrode of platinum (area: 7 mm²), a counter electrode (area: 4 mm²) and a reference electrode of silver/silver chloride (area: 1 mm²).

Then, on the overall surface was spin-coated a 1 v/v % solution of γ-aminopropyltriethoxysilane to form a binding layer, on which was then spin-coated a 5 w/v % perfluorocarbon sulfonic acid resin to form an ion-exchange resin-layer comprising the perfluorocarbon sulfonic acid resin (Nafion) as a main component. Then, on the surface was spin-coated a 22.5 w/v % solution of albumin containing glutaraldehyde at 1 v/v %, to form an immobilized enzyme layer.

Then, over the whole surface of the immobilized enzyme layer was spin-coated a fluoroalcohol ester of a methacrylate resin prepared as a 0.3 wt % solution in perfluorohexane, and the product was dried to form a permeation limiting layer. Spin coating was conducted under the conditions of 3000 rpm and 30 sec.

Next, on a case produced using an acrylonitrile-butadiene-styrene resin were mounted a sensor, a waterproof seal and a terminal, and then the sensor and the terminal was connected using wire bonding. A silicone resin was injected into immersible places for waterproofing.

The sensor in the measuring apparatus thus prepared was immersed in the storage solutions having the compositions shown in Table 2, and a voltage of 450 mV with reference to the reference electrode was applied to the working electrode. Then, a response current to 500 mg/dL glucose was determined. As a comparative example, a referential storage solution was also similarly prepared and subjected to determination of a response current to 500 mg/dL glucose. A temperature of the storage solutions during the experiment was 40° C. and the experiment was conducted for seven consecutive days.

TABLE 2

| | | | Referential |
|---|---|---|---|
| | Storage | Storage | storage |
| | solution 1 | solution 2 | solution 1 |
| 5-c-2-m-4-I-3-o* | 0.209 ppm | 2.089 ppm | 0 ppm |
| 2-m-4-I-3-o** | 0.0716 ppm | 0.716 ppm | 0 ppm |
| MgCl₂ | 0.128 ppm | 1.28 ppm | 0 ppm |
| Mg(NO₃)₂ | 0.398 ppm | 3.98 ppm | 0 ppm |
| TES | 100 mM | 100 mM | 100 mM |
| NaCl | 150 mM | 150 mM | 150 mM |
| NaN₃ | 0 ppm | 0 ppm | 0.1 ppm |
| pH | 7 | 7 | 7 |

In Table 2, “*” and “**” denote 5-chloro-2-methyl-4-isothiazolin-3-one and 2-methyl-4-isothiazolin-3-one, respectively.

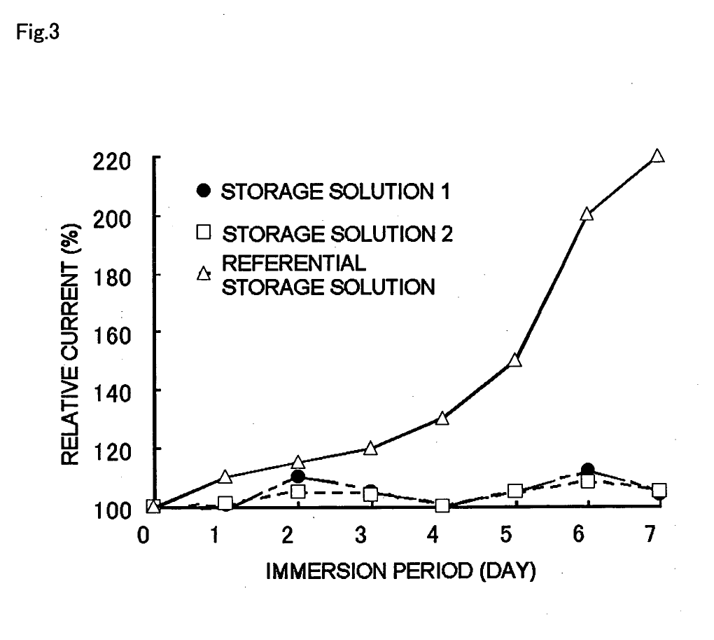

The experimental results are shown in FIG. 3, in which current values during seven days are plotted as a relative value (relative current) to a response current at the beginning of the experiment (100%). Thus, it was found that for the storage solutions 1 and 2, a stable current was obtained while for the referential storage solution, a current value was increased over time so that a stable current could not be obtained.

### Example 3

On a 10 mm×6 mm quartz substrate were formed a working electrode of platinum (area: 7 mm²), a counter electrode (area: 4 mm²) and a reference electrode of silver/silver chloride (area: 1 mm²).

Then, on the overall surface was spin-coated a 1 v/v % solution of γ-aminopropyltriethoxysilane to form a binding layer, on which was then spin-coated a 5 w/v % perfluorocarbon sulfonic acid resin to form an ion-exchange resin layer comprising the perfluorocarbon sulfonic acid resin (Nafion) as a main component. Then, on the surface was spin-coated a 22.5 w/v % solution of albumin containing glutaraldehyde at 1 v/v %, to form an immobilized enzyme layer.

Then, over the whole surface of the immobilized enzyme layer was spin-coated a fluoroalcohol ester of a methacrylate resin prepared as a 0.3 wt % solution in perfluorohexane, and the product was dried to form a permeation limiting layer. Spin coating was conducted under the conditions of 3000 rpm and 30 sec.

Next, on a case produced using an acrylonitrile-butadiene-styrene resin were mounted a sensor, a waterproof seal and a terminal, and then the sensor and the terminal was connected using wire bonding. A silicone resin was injected into immersible places for waterproofing.

The sensor in the measuring apparatus thus prepared was immersed in the storage solutions having the compositions shown in Table 3, and the sensor was subjected to cyclic voltammetry. A voltage of the working electrode with reference to the reference electrode was swept. A sweep speed was 10 mV/sec. In Table 3, 5-c-2-m-4-I-3-o and 2-m-4-I-3-o denote 5-chloro-2-methyl-4-isothiazolin-3-one and 2-methyl-4-isothiazolin-3-one, respectively.

TABLE 3

| | Storage | Referential storage |
|---|---|---|
| | solution | solution |
| 5-c-2-m-4-I-3-o | 0.209 ppm | 0 ppm |
| 2-m-4-I-3-o | 0.0716 ppm | 0 ppm |
| MgCl₂ | 0.128 ppm | 0 ppm |
| Mg(NO₃)₂ | 0.398 ppm | 0 ppm |
| TES | 100 mM | 100 mM |
| NaCl | 150 mM | 150 mM |
| NaN₃ | 0 ppm | 0 ppm |
| pH | 7 | 7 |

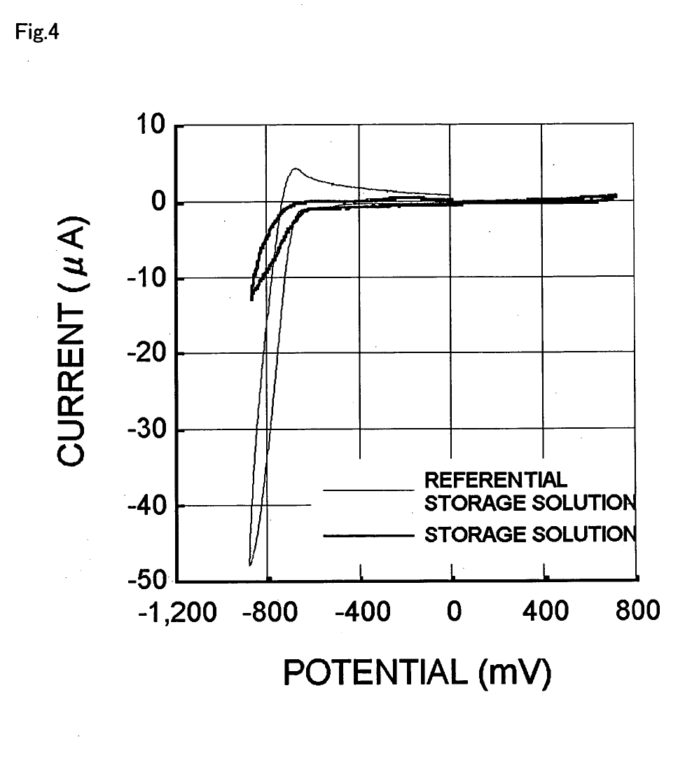

FIG. 4 shows the experimental results. It was observed that when using the storage solution of this example, a less current was conducted than that in the referential storage solution and the effect was particularly significant in a negative potential range. In other words, it is indicated that the storage solution of this example can prevent an excess current from flowing so that a sensor can be reliably used for a long term. It is probably because the thiazoline compound in the storage solution was adsorbed in the electrode surface and acted as a protective film.

### Example 4

On a 10 mm×6 mm quartz substrate were formed a working electrode of platinum (area: 7 mm²), a counter electrode (area: 4 mm²) and a reference electrode of silver/silver chloride (area: 1 mm²).

Then, on the overall surface was spin-coated a 1 v/v % solution of γ-aminopropyltriethoxysilane to form a binding layer, on which was then spin-coated a 5 w/v % perfluorocarbon sulfonic acid resin to form an ion-exchange resin layer comprising the perfluorocarbon sulfonic acid resin (Nafion) as a main component. Then, on the surface was spin-coated a 22.5 w/v % solution of albumin containing glutaraldehyde at 1 v/v %, to form an immobilized enzyme layer.

Then, over the whole surface of the immobilized enzyme layer was spin-coated a fluoroalcohol ester of a methacrylate resin prepared as a 0.3 wt % solution in perfluorohexane, and the product was dried to form a permeation limiting layer. Spin coating was conducted under the conditions of 3000 rpm and 30 sec.

Next, on a case produced using an acrylonitrile-butadiene-styrene resin were mounted a sensor, a waterproof seal and a terminal, and then the sensor and the terminal was connected using wire bonding. A silicone resin was injected into immersible places for waterproofing.

The sensor in the measuring apparatus thus prepared was immersed in eight storage solutions (storage solutions 1 to 8) having the compositions shown in Tables 4, 5, 6 and 7, and a voltage of 450 mV with reference to the reference electrode was applied to the working electrode. Then, a response current to 500 mg/dL glucose was determined. Similarly, as a comparative example, the sensor was immersed in a referential storage solution (storage solution 9) and a response current to 500 mg/dL glucose was determined. A temperature of the storage solutions during the experiment was 40° C. and the experiment was conducted for seven consecutive days. All the storage solutions contain 100 mM TES and 150 mM NaCl at pH=7. The referential storage solution (storage solution 9) contains 100 mM TES, 150 mM NaCl and 0.1 ppm NaN₃ as shown in Table 1.

TABLE 4

| | Storage solution 1 | Storage solution 2 |
|---|---|---|
| 5-c-2-e-4-I-3-o | 0.2 ppm | 2.1 ppm |
| 2-m-4-I-3-o | 0.07 ppm | 0.72 ppm |
| MgCl₂ | 0.12 ppm | 1.28 ppm |
| Mg(NO₃)₂ | 0.39 ppm | 3.98 ppm |

TABLE 5

| | Storage solution 3 | Storage solution 4 |
|---|---|---|
| 5-c-2-e-4-I-3-o | 0.2 ppm | 2.1 ppm |
| 5-m-4-I-3-o | 0.07 ppm | 0.72 ppm |
| MgCl₂ | 0.12 ppm | 1.28 ppm |
| Mg(NO₃)₂ | 0.39 ppm | 3.98 ppm |

TABLE 6

| | Storage solution 5 | Storage solution 6 |
|---|---|---|
| 5-c-2-m-4-I-3-o | 0.2 ppm | 2.1 ppm |
| 5-m-4-I-3-o | 0.07 ppm | 0.72 ppm |
| MgCl₂ | 0.12 ppm | 1.28 ppm |
| Mg(NO₃)₂ | 0.39 ppm | 3.98 ppm |

TABLE 7

| | Storage solution 7 | Storage solution 8 |
|---|---|---|
| 5-c-2-m-4-I-3-o | 0.2 ppm | 2.1 ppm |
| 2-e-4-I-3-o | 0.07 ppm | 0.72 ppm |
| MgCl₂ | 0.12 ppm | 1.28 ppm |
| Mg(NO₃)₂ | 0.39 ppm | 3.98 ppm |

In Tables 4 and 5, 5-c-2-e-4-I-3-o denotes 5-chloro-2-ethyl-4-isothiazolin-3-one; in Tables 5 and 6, 5-m-4-I-3-o denotes 5-methyl-4-isothiazolin-3-one; and in Table 7, 2-e-4-I-3-o denotes 2-ethyl-4-isothiazolin-3-one.

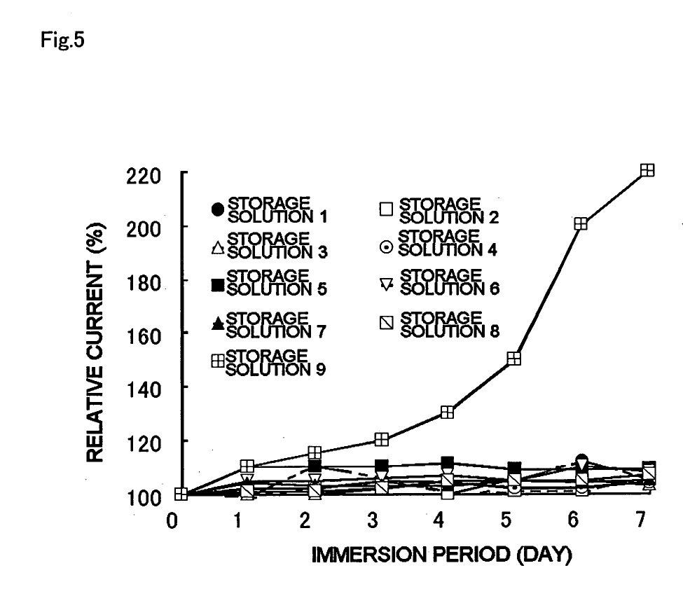

The experimental results are shown in FIG. 5, in which current values during seven days are plotted as a relative value (relative current) to a response current at the beginning of the experiment (100%). Thus, it was found that for the storage solutions other than the referential storage solution, a stable current was obtained while for the referential storage solution, a current value was increased over time so that a stable current could not be obtained.

### Example 5

On a 10 mm×6 mm quartz substrate were formed a working electrode of platinum (area: 7 mm²), a counter electrode (area: 4 mm²) and a reference electrode of silver/silver chloride (area: 1 mm²).

Then, on the overall surface was spin-coated a 1 v/v % solution of γ-aminopropyltriethoxysilane to form a binding layer. Then, over the whole surface of the binding layer was spin-coated a fluoroalcohol ester of a methacrylate resin prepared as a 0.3 wt % solution in perfluorohexane, and the product was dried to form a permeation limiting layer. Spin coating was conducted under the conditions of 3000 rpm and 30 sec.

Next, on a case produced using an acrylonitrile-butadiene-styrene resin were mounted a sensor, a waterproof seal and a terminal, and then the sensor and the terminal was connected using wire bonding. A silicone resin was injected into immersible places for waterproofing.

The sensor in the measuring apparatus thus prepared was immersed in the storage solution having the composition shown in Table 8, i. e., storage solution 10, and while a voltage of 450 mV with reference to the reference electrode was applied to the working electrode, the apparatus was stored. A response current to 50 mM hydrogen peroxide was determined everyday. Similarly, as a comparative example, a referential storage solution was prepared and a response current to 50 mM hydrogen peroxide was determined. A temperature of the storage solutions during the experiment was 40° C. and the experiment was conducted for seven consecutive days. All the storage solutions contain 100 mM TES and 150 mM NaCl at pH=7. The referential storage solution (storage solution 9) contains 100 mM TES, 150 mM NaCl and 0.1 ppm NaN₃ as described in Example 4.

TABLE 8

| | Storage solution 10 |
|---|---|
| 5-c-2-m-4-I-3-o | 0.2 ppm |
| 2-e-4-I-3-o | 0.07 ppm |
| MgCl₂ | 0.12 ppm |
| Mg(NO₃)₂ | 0.39 ppm |

In Table 8, 2-e-4-I-3-o denotes 2-ethyl-4-isothiazolin-3-one.

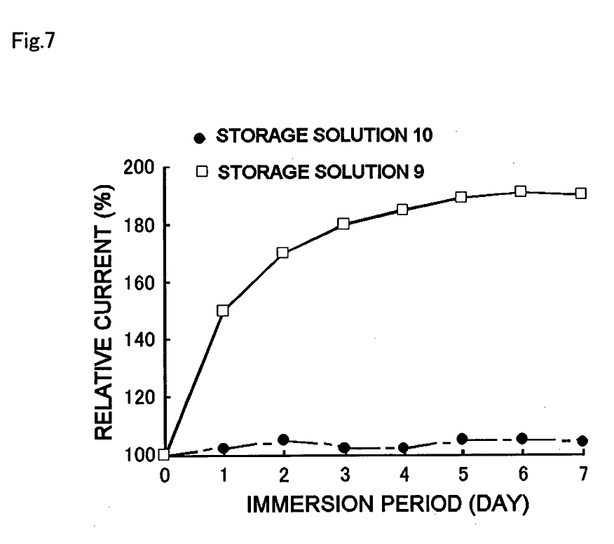

The experimental results are shown in FIG. 7, in which current values during seven days are plotted as a relative value (relative current) to a base current at the beginning of the experiment (100%). Thus, it was found that for storage solution 10, a stable current was obtained while for the referential storage solution (storage solution 9), a current value was increased over time so that a stable current could not be obtained.

### Example 6

To storage solution 1 in Example 1 and Table 1 was added glucose at 50, 100, 300, 500, 700, 1000, 2000 and 3000 mg/dl to prepare glucose calibration solutions. Seven days after the preparation, these calibration solutions were used for determining a glucose level in liquid samples by means of the sensor in Example 2.

The measured samples were 30 samples whose glucose level had been determined using by a clinical laboratory apparatus on the basis of a glucose dehydrogenase method (glucose level: 50 to 3000 mg/dl). Measured values were compared between the clinical laboratory apparatus and the above sensor to obtain a correlation equation. The storage solution used in the sensor was storage solution 1 described above.

The results showed that a correlation coefficient for the measured values by the sensor according to this example was about 1.0. Thus, it was confirmed that the calibration solutions had excellent temporal stability.

As described above, this invention can provide a sensor storage solution and a sensor calibration solution by which sensor performance can be satisfactorily maintained, by adding a compound containing a heterocycle having nitrogen and sulfur heteroatoms to the solutions.

This invention can also provide a sensor in which film detachment or inactivation of an enzyme layer can be prevented during storage.

What is claimed is:

1. A sensor storage solution comprising a compound containing a heterocycle having nitrogen and sulfur heteroatoms.

2. The sensor storage solution as claimed in claim 1,
wherein the compound is selected from the group consisting of thiazole, thiazoline, isothiazole, isothiazoline, thiazine and their derivatives.

3. The sensor storage solution as claimed in claim 1,
wherein the compound comprises oxo directly bound to the heterocycle.

4. The sensor storage solution as claimed in claim 1,
wherein the compound comprises halogen directly bound to the heterocycle.

5. A sensor calibration solution comprising a compound containing a heterocycle having nitrogen and sulfur heteroatoms.

6. The sensor calibration solution as claimed in claim 5,
wherein the compound is selected from the group consisting of thiazole, thiazoline, isothiazole, isothiazoline, thiazine and their derivatives.

7. The sensor calibration solution as claimed in claim 5,
wherein the compound comprises oxo directly bound to the heterocycle.

8. The sensor calibration solution as claimed in claim 5,
wherein the compound comprises halogen directly bound to the heterocycle

9. A sensor comprising:
a substrate;
an electrode formed on the substrate; and
a coating covering the electrode,
wherein the coating comprises a compound containing a heterocycle having nitrogen and sulfur heteroatoms.

10. The sensor as claimed in claim 9,
wherein the coating has a multilayer structure comprising one or more organic layers.

11. The sensor as claimed in claim 9,
wherein the coating comprises an enzyme.

12. The sensor as claimed in claim 9,
wherein the compound is selected from the group consisting of thiazole, thiazoline, isothiazole, isothiazoline, thiazine and their derivatives.

13. The sensor as claimed in claim 9,
wherein the compound comprises oxo directly bound to the heterocycle.

14. The sensor as claimed in claim 9,
wherein the compound comprises halogen directly bound to the heterocycle.
